(19) United States
(12) Patent Application Publication
(10) Pub. No.: US 2026/0254135 A1
(43) Pub. Date: Aug. 27, 2026

(54) TERMINAL CONNECTION STRUCTURE AND TERMINAL CONNECTION METHOD FOR COMMUNICATION CABLE

(71) Applicant: Proterial, Ltd., Tokyo (JP)

(72) Inventors: Hideyuki SAGAWA, Tokyo (JP); Detian HUANG, Tokyo (JP); Takahiro SUGIYAMA, Tokyo (JP)

(73) Assignee: Proterial, Ltd., Tokyo (JP)

(21) Appl. No.: 19/537,921

(22) Filed: Feb. 12, 2026

(30) Foreign Application Priority Data
Feb. 21, 2025 (JP) 2025-027319

(51) Int. Cl. H01R 4/48; H01R 4/02; H01R 4/18; H01R 13/405; H01R 43/02

(52) U.S. Cl. CPC H01R 4/48; H01R 4/023; H01R 4/185; H01R 13/405; H01R 43/0207

(57) ABSTRACT

A communication cable terminal connection structure to connect a terminal of a communication cable to a substrate, wherein the communication cable includes a pair of conductors arranged in parallel and an insulator covering a periphery of the pair of conductors collectively, wherein the substrate has signal electrodes to which the conductors are electrically connected, wherein the communication cable has conductor exposed portions exposing the pair of conductors to a predetermined length from an end of the insulator, wherein the conductors at the conductor exposed portions have connection portions, each connection portion being shaped to have a width in an arrangement direction of the pair of conductors smaller than a height in a direction perpendicular to both the arrangement direction and a longitudinal direction of the conductors, wherein a spacing between the connection portions is greater than a spacing between the pair of conductors in a covered portion where the conductors are covered by the insulator, and wherein the connection portions are connected to the signal electrodes respectively by soldering or welding

### CROSS-REFERENCE TO RELATED APPLICATIONS

The present application is based on Japanese patent application No. 2025-027319 filed on Feb. 21, 2025, the entire contents of which are incorporated herein by reference.

### TECHNICAL FIELD

The present invention relates to a terminal connection structure and a terminal connection method for a communication cable.

### BACKGROUND OF THE INVENTION

Conventionally, a differential signal transmission cable known as a two-core parallel cable (or Twinax cable) has been employed as a communication cable for transmitting signals exceeding several Gbit/s. This cable is composed of two insulated wires arranged in parallel, with a shielding tape being wrapped around the two insulated wires. However, when transmitting high-speed signals exceeding several tens of Gbit/s, it is necessary to reduce the spacing between conductors to strengthen electromagnetic coupling between the conductors (i.e., achieve strong coupling), in order to suppress intra-pair skew and ensure normal signal transmission.

Therefore, for transmitting high-speed signals exceeding tens of Gbit/s, a communication cable has been used where a pair of parallel conductors are covered with an insulator collectively, and shielding tape is wrapped around the insulator. When connecting this communication cable to a substrate, first, the insulator is removed at the cable terminal to expose the pair of conductors. Then the exposed conductors are connected to the signal electrodes on the substrate by soldering or welding.

Patent Literature 1 is a prior art literature related to the invention according to the present application.

### CITATION LIST

Patent Literature 1: JP 2011-086458A

### SUMMARY OF THE INVENTION

However, in the aforementioned communication cable, the spacing between the conductors is narrowed to enhance electromagnetic coupling. Consequently, the spacing between the signal electrodes connecting the conductors becomes extremely narrow as well. As a result, solder tends to bridge to adjacent electrodes while making a connection by soldering, and it also makes the welding difficult.

Furthermore, there is a problem that the narrow spacing of the signal electrodes causes the impedance to become extremely low at the connection point between the communication cable and the substrate, leading to degradation of signal quality.

Therefore, it is an object of the present invention to provide a terminal connection structure and a communication cable terminal connection method, which facilitate connection between conductors and signal electrodes and suppress degradation of signal quality even when the conductor spacing is narrow in the communication cable.

In order to solve the above problem, one aspect of the present invention provides a communication cable terminal connection structure to connect a terminal of a communication cable to a substrate,
wherein the communication cable comprises a pair of conductors arranged in parallel and an insulator covering a periphery of the pair of conductors collectively,
wherein the substrate has signal electrodes to which the conductors are electrically connected,
wherein the communication cable has conductor exposed portions exposing the pair of conductors to a predetermined length from an end of the insulator,
wherein the conductors at the conductor exposed portions have connection portions, each connection portion being shaped to have a width in an arrangement direction of the pair of conductors smaller than a height in a direction perpendicular to both the arrangement direction and a longitudinal direction of the conductors,
wherein a spacing between the connection portions is greater than a spacing between the pair of conductors in a covered portion where the conductors are covered by the insulator, and
wherein the connection portions are connected to the signal electrodes respectively by soldering or welding.

In order to solve the above problem, another aspect of the present invention also provides a communication cable terminal connection method for connecting a terminal of a communication cable to a substrate, wherein the communication cable comprises a pair of conductors arranged in parallel and an insulator covering a periphery of the pair of conductors collectively, and wherein the substrate has signal electrodes to which the conductors are electrically connected, the communication cable terminal connection method comprising:
a conductor exposure step of forming a conductor exposed portion by exposing the pair of conductors to a predetermined length from an end of the insulator in the communication cable;
a connection portion shaping step of forming connection portions by shaping the conductors at the conductor exposed portions in such a manner that each connection portion has a width in an arrangement direction of the pair of conductors smaller than a height in a direction perpendicular to both the arrangement direction and a longitudinal direction of the conductors, while making a spacing between the connection portions larger than a spacing between the pair of conductors in a covered portion covered by the insulator; and
a connection step of connecting the connection portions to the signal electrodes respectively by soldering or welding.

### ADVANTAGEOUS EFFECTS OF THE INVENTION

According to the present invention, it is possible to provide a terminal connection structure and a communication cable terminal connection method which facilitate connection between conductors and signal electrodes and suppresses degradation of signal quality, even when a spacing between the conductors is narrow in a communication cable.

### BRIEF DESCRIPTION OF THE DRAWINGS

FIGS. 1A to 1C are diagrams showing a communication cable terminal connection structure according to an embodiment of the present invention.

FIG. 1A is a side view.

FIG. 1B is a plan view.

FIG. 1C is a sectional view taken along the line A-A in FIG. 1B.

FIG. 2A is a flowchart illustrating steps of a communication cable terminal connection method according to an embodiment of the present invention.

FIG. 2B is a flowchart of the connection portion shaping step.

FIG. 3A is an explanatory diagram of a first compression step.

FIG. 3B is an explanatory diagram of a second compression step.

FIG. 3C is an explanatory diagram of a third compression step.

FIGS. 4A to 4C are explanatory diagrams of the first compression step.

FIGS. 5A and 5B are explanatory diagrams of a modified example of the first compression step.

FIGS. 6A to 6F are explanatory diagrams of modified examples of the connection portion shaping step.

### DETAILED DESCRIPTION OF THE INVENTION

### Embodiment

The following describes an embodiment of the present invention with reference to the accompanying drawings.

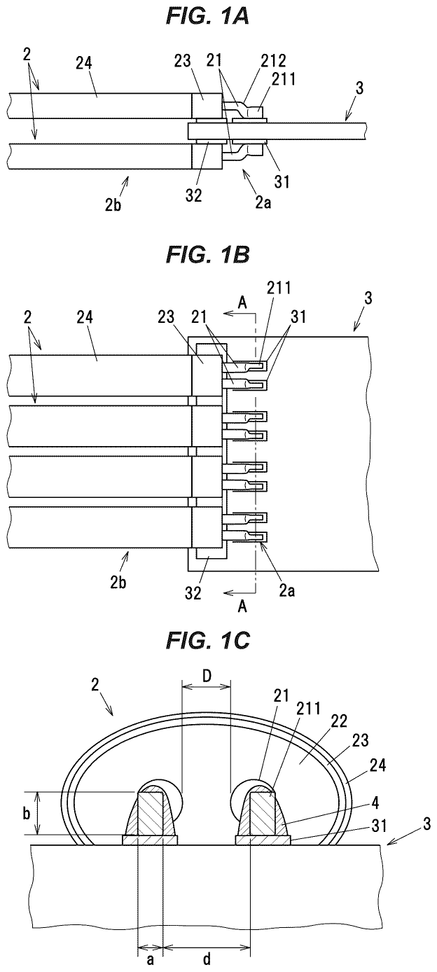

FIGS. 1A to 1C are diagrams showing a terminal connection structure 1 for a communication cable according to the present embodiment.
FIG. 1A is a side view.
FIG. 1B is a plan view.
FIG. 1C is a sectional view taken along the line A-A in FIG. 1B.
As shown in FIGS. 1A to 1C, the terminal connection structure 1 for a communication cable is a structure for connecting a terminal of a communication cable 2 to a substrate 3.

### Communication Cable 2

The communication cable 2 is a differential signal transmission cable for transmitting differential signals, and is used, for example, to transmit high-speed signals exceeding tens of Gbit/s.

The communication cable 2 comprises a pair of conductors 21 arranged in parallel to each other, an insulator 22 covering a periphery of the pair of conductors 21 collectively, a shield layer 23 covering a periphery of the insulator 22, and a jacket layer 24 covering a periphery of the shield layer 23.

The pair of conductors 21 comprises, for example, single-wire conductors made of silver-plated soft copper wire. A positive side signal of the differential signal (positive signal) is transmitted to one of the conductors 21, while a negative side signal of the differential signal (negative signal) is transmitted to the other conductor 21. Additionally, the pair of conductors 21 may be configured from compressed stranded wire conductors, which are made by twisting together multiple metal strands and then compressing them to form a circular cross-sectional shape.

The insulator 22 may, for example, be made of foamed polyethylene. The cross-sectional shape of the insulator 22 (a cross-section perpendicular to the longitudinal direction) is approximately elliptical. The pair of conductors 21 is arranged parallel to a long axis of the insulator 22. To accommodate the transmission of high-speed signals exceeding tens of Gbit/s, the spacing between the pair of conductors 21 is set relatively narrow. The spacing between the pair of conductors 21 is, for example, from 0.2 mm to 0.5 mm (0.2 mm or more and 0.5 mm or less). The outer diameter of the cable is, for example, as follows: the length of a long axis of the roughly elliptical shape is from 1.0 mm to 2.5 mm (1.0 mm or more and 2.5 mm or less), and the length of a short axis is from 0.5 mm to 1.2 mm (0.5 mm or more and 1.2 mm or less).

The shield layer 23 is formed, for example, from a copper foil sheet. The shield layer 23 is formed by longitudinally winding the copper foil. The jacket layer 24 is formed, for example, from a resin composition primarily composed of heat-resistant PVC (polyvinyl chloride). Note that the communication cable 2 does not include a drain wire for grounding the shield layer 23. The terminal processing of the communication cable 2 will be described later.

### Substrate 3

The substrate 3 is, for example, an internal substrate of a connector connected to communication equipment or the like. The substrate 3 is composed of an insulating material such as epoxy resin and is formed in a plate shape.

A plurality of signal electrodes 31, to which the conductors 21 of the communication cable 2 are electrically connected, are provided on both a front surface and a back surface of the substrate. In an illustrated example, four communication cables 2 are connected to the front surface and the back surface of the substrate 3 respectively. Therefore, four pairs of signal electrodes 31 are provided on the front surface and the back surface of the substrate 3 respectively.

Also, a single ground electrode 32, to which the shield layer 23 of the communication cable 2 is electrically connected, is provided on both the front surface and the back surface of the substrate 3. The shield layers 23 of the four communication cables 2 connected to the front surface of the substrate 3 are connected to the single common ground electrode 32. In the same manner, the shield layers 23 of the four communication cables 2 connected to the back surface of substrate 3 are connected to the single common ground electrode 32. The ground electrode 32 is positioned closer to an extension end of the communication cables 2 than the signal electrodes 31 on the substrate 3 and is arranged along an edge of the substrate 3.

The number of communication cables 2 connected to the substrate 3 is not limited to what is shown in the illustrated example. Additionally, the communication cables 2 may be connected to either the front surface or the back surface of substrate 3.

### Terminal Processing of Communication Cable 2, Connection of Communication Cable 2 to Substrate 3

The communication cable 2 has a conductor exposed portion 2a where a pair of conductors 21 are exposed from an end of the insulator 22 to a predetermined length. Furthermore, at the terminal end of the communication cable 2, a predetermined length of the jacket layer 24 is removed and the shield layer 23 is exposed at the base end side of the conductor exposed portion 2a.

The conductor 21 at the conductor exposed portion 2a has a connection portion 211 shaped in such a manner that a width “a” of the conductor 21 in the arrangement direction of the pair of conductors 21 (long axis direction of the insulator 22) is smaller than a height “b” of the conductor 21 in the direction perpendicular to the arrangement direction and the longitudinal direction of the conductors 21 (short axis direction of the insulator 22). The connection portion 211 is formed at each end (tip portion) of the pair of conductors 21 in the conductor exposed portion 2a. The width a of the connection portion 211 is at least smaller than a diameter of the conductor 21 before shaping (the diameter of the conductor 21 in the portion having a circular cross-sectional shape). Furthermore, a spacing d between the connection portions 211 of the pair of conductors 21 (the spacing along the width direction) is made larger than a spacing D between the pair of conductors 21 in the covered portion 2b.

With the above configuration, even when using the communication cable 2 whose spacing D between the conductors 21 is narrow, it becomes possible to widen the spacing d between the conductors 21 (between the connection portions 211) at the connection portion to the substrate 3. As a result, it also becomes possible to widen the spacing between the signal electrodes 31 of the substrate 3 that connect the conductors 21, enabling easier soldering or welding operations. Furthermore, widening the spacing between the conductors 21 and the signal electrodes 31 suppresses an extreme drop in impedance at the connection point between the communication cable 2 and the substrate 3 (i.e., the connection point between the conductors 21 and the signal electrodes 31), thereby suppressing signal quality degradation.

Hereinafter, the term “width” refers to a dimension in the arrangement direction of a pair of conductors 21 (the longitudinal direction of the insulator 22, a left-right direction in FIG. 1C). The arrangement direction of the pair of conductors 21 is referred to as the “width direction.” The term “height” refers to a dimension in the direction perpendicular to the width direction and the longitudinal direction of the conductors 21 (the short axis direction of the insulator 22, a vertical direction in FIG. 1C). The direction perpendicular to the width direction and the longitudinal direction of the conductors 21 is referred to as the “height direction.”

A height b of the connection portion 211 should preferably be from 1.5 times to 2.0 times (1.5 times or more and 2.0 times or less) the width a. By setting the height b of the connection portion 211 to be 1.5 times or more the width a, the spacing between conductors 21 (between the connection portions 211) can be sufficiently widened, facilitating connection work while also suppressing degradation of signal quality due to impedance reduction. Setting the height b of the connection portion 211 to 2.0 times or less the width a prevents the connection portion 211 from becoming excessively tall and the width from becoming excessively narrow, thereby suppressing a decrease in a connection strength to the signal electrode 31.

Furthermore, the connection portion 211 is shaped in such a manner that a portion contacting the signal electrode 31 is planar. Here, the connection portion 211 is configured to have a cross-sectional shape that is approximately rectangular.

Since the connection portion 211 makes a planar contact with the signal electrode 31 in this configuration, a connection operation between the connection portion 211 and the signal electrode 31 can be performed stably by soldering, etc. and the connection strength between the connection portion 211 and the signal electrode 31 can be improved.

The conductor 21 exposed at the conductor exposed portion 2a has a bending portion 212 where the conductor 21 is bent in a crank shape toward the substrate 3, at the base end side of the connection portion 211 (see FIG. 1A). Note that the bending portion 212 is not essential and may be omitted.

In the present embodiment, the connection portions 211 of the pair of conductors 21 are connected to the signal electrodes 31 respectively, by soldering using solder 4. However, this is not limited thereto; the connection portions 211 of the pair of conductors 21 may be connected to the signal electrodes 31 by welding. For simplicity in the drawings, the solder 4 is omitted in FIGS. 1A and 1B. In the same manner, the shield layer 23 is connected to the ground electrode 32 by soldering or welding.

In the present embodiment, since the cross-sectional shape of the conductor 21 is approximately rectangular, the widthwise bulge of the solder 4 can be reduced compared with a case where a circular cross-sectional conductor of equal conductor cross-sectional area is soldered.

Furthermore, in the present embodiment, since the width a of the connection portion 211 can be reduced, the width of the signal electrode 31 can also be reduced accordingly. As a result, it becomes possible to widen the spacing between the signal electrodes 31. More specifically, it is preferable that the spacing between the signal electrodes 31 be from 1.01 times to 1.30 times (1.01 times or more and 1.30 times or less) of the spacing D between the conductors 21.

### Terminal Connection Method for Communication Cable

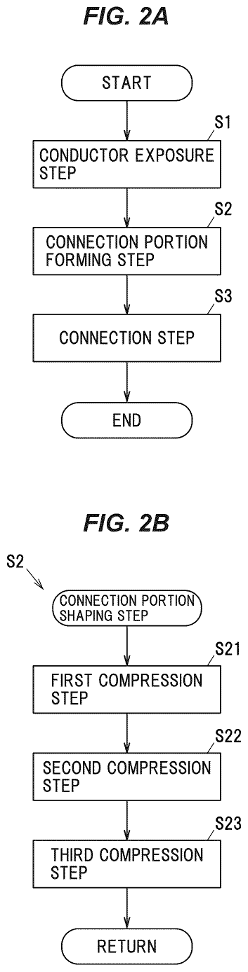

FIG. 2A is a flowchart illustrating the steps of the communication cable terminal connection method according to the present embodiment.

As shown in FIG. 2A, first, the conductor exposure step of a step S1 is performed. In this conductor exposure step, the pair of conductors 21 is exposed from the end of the insulator 22 to the predetermined length in the communication cable 2 to form the conductor exposed portion 2a. Also, the shield layer 23 is exposed by removing the jacket layer 24 at the base end side of the conductor exposed portion 2a.

Next, the connection portion shaping step in a step S2 is performed. In the connection portion shaping step, the ends of the pair of conductors 21 exposed at the conductor exposed portion 2a are shaped in such a manner that the width a of the pair of conductors 21 is smaller than the height b, thereby forming the connection portion 211. At the same time, the spacing d between these connection portions 211 is made larger than the spacing D between the pair of conductors 21 in a covered portion 2b where the conductors 21 are covered by the insulator 22.

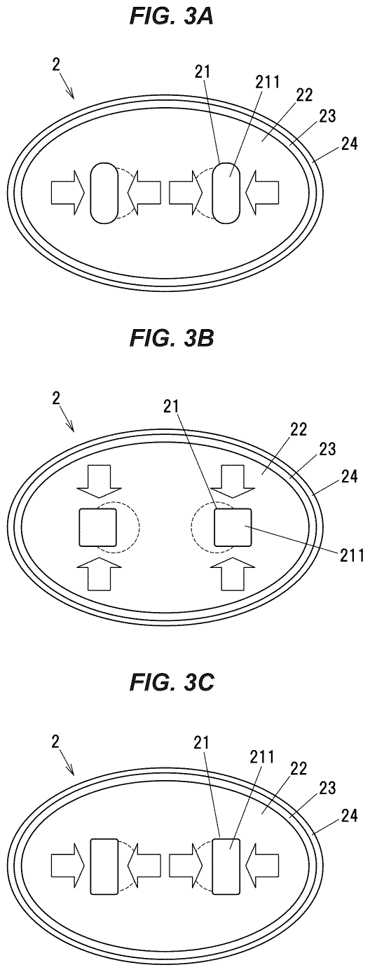

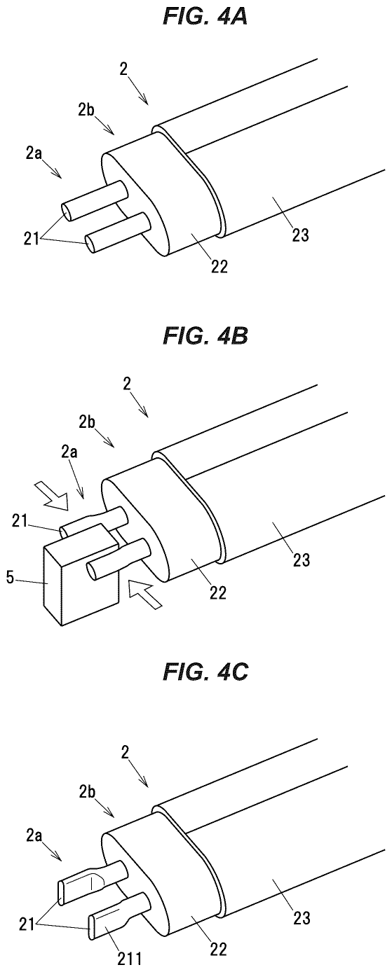

More specifically, as shown in FIG. 2B, first of all, a first compression step in a step S21 is performed. In the first compression step, as shown in FIG. 3A, the pair of conductors 21 is compressed in the width direction (the arrangement direction of the conductors 21). When performing the first compression step, as shown in FIGS. 4A to 4C, it is preferable to insert a plate-shaped spacer 5 between the pair of conductors 21 to widen the spacing between the conductors 21, and then compress the conductors 21 in the width direction in that state.

After the first compression step in the step S21, a second compression step in a step S22 is performed. In the second compression step, as shown in FIG. 3B, a pair of conductors 21 is compressed in the height direction. Before performing the second compression step, i.e., after performing the first compression step, upper and lower surfaces in the height direction are curved (see FIG. 3A). However, by performing the second compression, the upper and lower surfaces in the height direction are flattened, and the cross-sectional shape of the connection portions 211 become approximately rectangular. In other words, performing the second compression step shapes the connection portion 211 in such a manner that the portion contacting the signal electrode 31 becomes planar.

After the second compression step in the step S22, the third compression step in a step S23 is performed. In the third compression step, as shown in FIG. 3C, the pair of conductors 21 are recompressed in the height direction. This shapes the connection portion 211 in such a manner that the width a becomes smaller than the height b. Subsequently, the step returns to a step S3 in FIG. 2A.

The second compression step in the step S22 and the third compression step in the step S23 may be omitted. However, in this case, the surface connecting to the signal electrode 31 at the connection portion 211 becomes curved. This makes it difficult to stabilize a posture when connecting the connection portion 211 and the signal electrode 31 by soldering or similar methods, potentially complicating the connection work and reducing the connection strength. Therefore, it is preferable to perform the second compression step in the step S22 and the third compression step in the step S23. Additionally, by reducing the compression amount in the second compression step, it is possible to omit the third compression step.

In the step S3, the connection step is performed. In the connection step, the connection portions 211 of the pair of conductors 21 are connected to the signal electrodes 31 of the substrate 3 respectively by soldering. Also, the shield layer 23 of the communication cable 2 is connected to the ground electrode 32 of the substrate 3 by soldering. By connecting each communication cable 2 to the substrate 3 according to the steps in FIG. 2A, the terminal connection structure 1 of the communication cable shown in FIGS. 1A to 1C is obtained.

FIG. 2A did not show the formation of a bending portion 212 in the conductor 21. However, when forming the bending portion 212, it is preferable to insert a step for forming the bending portion 212 between the conductor exposure step in the step S1 and the connection portion shaping step in the step S2, or between the connection portion shaping step in the step S2 and the connection step in the step S3.

### Modified Example

When the conductor 21 is formed from a compressed stranded conductor, a preliminary soldering may be performed on the tip of the conductor 21 to suppress the separation of the metal strands during compression in the connection portion shaping step.

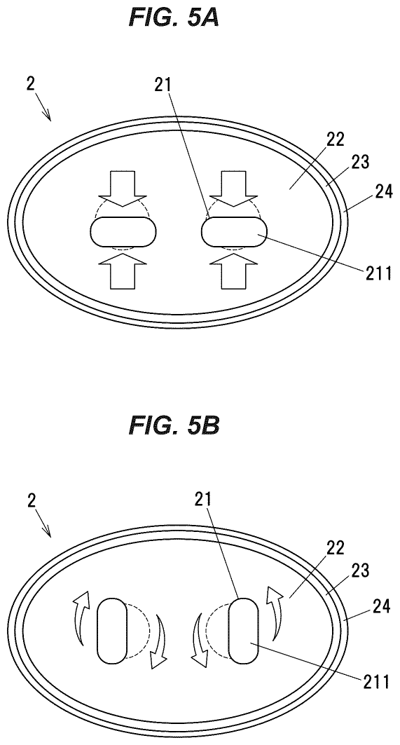

Furthermore, when the conductor 21 is a compressed stranded conductor, as shown in FIGS. 5A and 5B, the first compression step may be performed with the compressed portion rotated 90° after compressing the pair of conductors 21 in the height direction. This allows the spacer 5 (see FIG. 4B) to be omitted. Furthermore, by reducing the compression amount in the second compression step and omitting the third compression step, it becomes possible to omit a mechanism for compressing in the width direction.

In this case, it is preferable that the compressed portion is rotated in the direction that tightens a twist of the compressed stranded conductor in the first compression step. This suppresses the untwisting of the metal strands at the connection portion 211 and prevents the metal strands from spreading apart. In the examples of FIGS. 5A and 5B, since the pair of conductors 21 are rotated in directions opposite to each other, it is desirable for the twisting directions of the pair of conductors 21 to be opposite to each other as well. Furthermore, when the twisting directions of the pair of conductors 21 are in the same direction, it is desirable to rotate the pair of conductors 21 in the same direction during the first compression step.

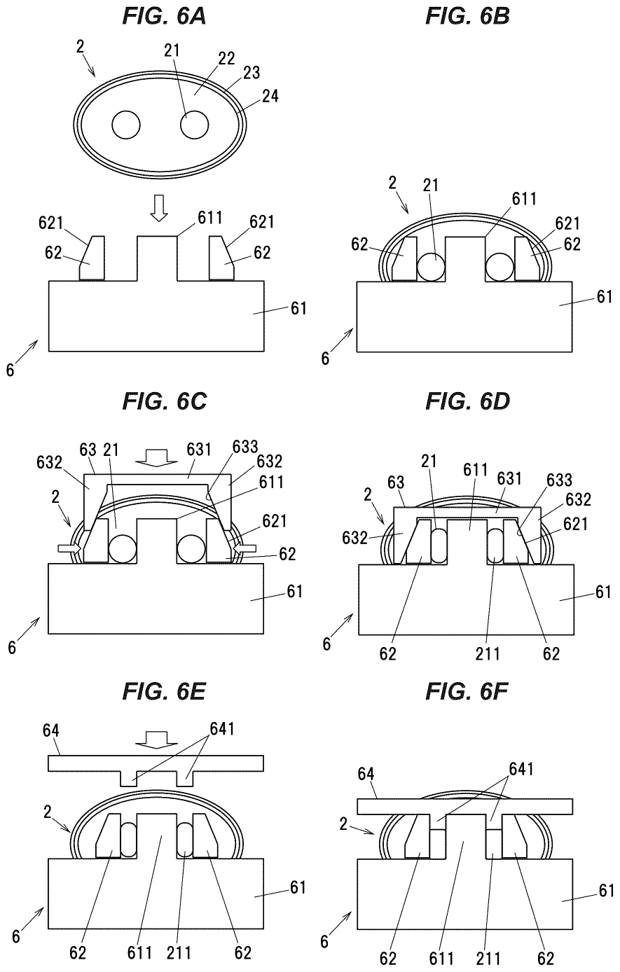

Additionally, as shown in FIGS. 6A to 6F, a dedicated mold 6 may be used to form the connection portion 211. The mold 6 shown in FIGS. 6A to 6F comprises a lower mold 61, a pair of transverse molds (horizontal molds) 62 movably mounted on the lower mold 61, a first upper mold 63, and a second upper mold 64. Hereinafter, the upper side in FIGS. 6A to 6F is referred to as “up (upward),” and the lower side as “down (downward).”

The lower mold 61 has a partition 611 protruding upward from its upper surface. This partition 611 is inserted between the pair of conductors 21. The transverse molds 62 are positioned in such a manner that they sandwich the conductors 21 between themselves and the partition 611. The transverse mold 62 has an inclined surface 621 which is sloping to gradually move away from the partition 611 as it goes downward of the partition 611 and its opposite surface. The first upper mold 63 integrally comprises a plate-like central portion 631 and a pair of side walls 632 extending downward from both ends of the central portion 631. An inclined surface 633 corresponding to the inclined surface 621 of the transverse mold 62 is formed on the inner surface of the side walls 632. Also, the second upper mold 64 is formed in a plate shape and has a pair of projections 641 protruding downward from its lower surface. The projections 641 are used to compress the conductors 21 in the height direction.

As shown in FIGS. 6A and 6B, first of all, a pair of conductors 21 is placed on the lower mold 61 in such a manner that they sandwich the partition 611 of the lower mold 61, with a transverse mold 62 positioned on each side of the conductors 21. Then, as shown in FIGS. 6C and 6D, the first upper mold 63 is moved downward to sandwich the both transverse molds 62 (transverse molds 62, conductors 21, and partition 611) between the side walls 632. During this movement, the inclined surfaces 621 and 633 slide against each other, pushing the transverse molds 62 toward the partition 611 and compressing the conductors 21 in the width direction (the first compression step). After that, as shown in FIGS. 6E and 6F, the first upper mold 63 is retracted, and the second upper mold 64 is moved downward. At this time, the conductors 21, sandwiched between the transverse molds 62 and the partition 611, are pushed downward by the projections 641, being compressed in the height direction (the second compression step). Through the above steps, the connection portion 211 is formed. When using the mold 6, since the conductors 21 are compressed in the height direction while being sandwiched between the transverse mold 62 and the partition 611, the compression prevents the conductors 21 from spreading in the width direction. Therefore, the third compression step, which recompresses the conductors 21 in the width direction, can be omitted.

### Advantageous Effects of the Embodiment

As described above, in the terminal connection structure 1 for a communication cable according to the present embodiment, the pair of exposed conductors 21 has the connection portions 211 shaped at their ends in such a manner that the width a of the pair of conductors 21 is smaller than the height b. The spacing between the connection portions 211 of the pair of conductors 21 is larger than the spacing between the pair of conductors 21 in the covered portion 2b where the conductors 21 are covered by the insulator 22.

This configuration allows the spacing between the connection portions 211 and the spacing between the signal electrodes 31 to be increased, which facilitates connection between the conductors 21 and the signal electrodes 31 by soldering or similar methods. Also, increasing the spacing between the connection portions 211 and the spacing between the signal electrodes 31 suppresses a decrease in impedance as well as deterioration of signal quality.

### Summary of Embodiments

Next, technical ideas understood from the above embodiment, will be described with reference to the reference numerals and the like used in the embodiments. However, each reference numeral in the following description does not limit the constituent elements in the scope of claims to the members and the like specifically shown in the embodiments.

According to a first feature, a communication cable terminal connection structure to connect a terminal of a communication cable (2) to a substrate (3), has a configuration wherein the communication cable (2) comprises a pair of conductors (21) arranged in parallel and an insulator (22) covering a periphery of the pair of conductors (21) collectively, wherein the substrate (3) has signal electrodes (31) to which the conductors (21) are electrically connected, wherein the communication cable (2) has conductor exposed portions (2a) exposing the pair of conductors (21) to a predetermined length from an end of the insulator (22), wherein the conductors (21) at the conductor exposed portions (2a) have connection portions (211), each connection portion (211) being shaped to have a width in an arrangement direction of the pair of conductors (21) smaller than a height in a direction perpendicular to both the arrangement direction and a longitudinal direction of the conductors (21), wherein a spacing between the connection portions (211) is greater than a spacing between the pair of conductors (21) in a covered portion (2b) where the conductors (21) are covered by the insulator (22), and wherein the connection portions (211) are connected to the signal electrodes (31) respectively by soldering or welding.

According to the second feature, in the communication cable terminal connection structure, as described by the first feature, the height of the connection portion (211) is 1.5 times or more and 2.0 times or less the width of the connection portion (211).

According to the third feature, in the communication cable terminal connection structure, as described by the first feature, the connection portion (211) is shaped in such a manner that a portion contacting the signal electrode is planar.

According to the fourth feature, in the communication cable terminal connection structure, as described by the first feature, the spacing between the signal electrodes (31) to which the pair of conductors (21) are connected is 1.01 times or more and 1.30 times or less the spacing between the pair of conductors (21) in the covered portion (2b) by the insulator (22).

According to the fifth feature, in the communication cable terminal connection structure, as described by the first feature, each of the conductors (21) comprises a compressed stranded conductor composed of multiple metal strands being twisted together and compressed to have a circular cross-sectional shape.

According to the sixth feature, a communication cable terminal connection method for connecting a terminal of a communication cable (2) to a substrate (3), wherein the communication cable (2) comprises a pair of conductors (21) arranged in parallel and an insulator (22) covering a periphery of the pair of conductors (21) collectively, and wherein the substrate (3) has signal electrodes (31) to which the conductors (21) are electrically connected, and the communication cable terminal connection method comprises:
a conductor exposure step of forming a conductor exposed portion (2a) by exposing the pair of conductors (21) to a predetermined length from an end of the insulator (22) in the communication cable (2);
a connection portion shaping step of forming connection portions (211) by shaping the conductors (21) at the conductor exposed portions (2a) in such a manner that each connection portion (211) has a width in an arrangement direction of the pair of conductors (21) smaller than a height in a direction perpendicular to both the arrangement direction and a longitudinal direction of the conductors, while making a spacing between the connection portions (211) larger than a spacing between the pair of conductors (21) in a covered portion (2b) covered by the insulator (22); and
a connection step of connecting the connection portions (211) to the signal electrodes (31) respectively by soldering or welding.

According to the seventh feature, in the communication cable terminal connection method, as described by the sixth feature, the connection portion shaping step comprises: a first compression step of compressing the pair of conductors (21) in the arrangement direction; a second compression step of compressing the pair of conductors (21) in a direction perpendicular to both the arrangement direction and the longitudinal direction after the first compression step.

According to the eighth feature, in the communication cable terminal connection method, as described by the seventh feature, the connection portion shaping step further comprises a third compression step of recompressing the pair of conductors (21) in the arrangement direction after the second compression step.

According to the ninth feature, in the communication cable terminal connection method, as described the sixth feature, each of the conductors (21) comprises a compressed stranded conductor composed of multiple metal strands being twisted together and compressed to have a circular cross-sectional shape, and wherein the connection portion shaping step comprises a first compression step of compressing the pair of conductors (21) in the height direction and then rotating the compressed portions by 90°.

According to the tenth feature, in the communication cable terminal connection method, as described by the ninth feature, wherein the compressed portions are rotated in a direction to tighten a twist of the compressed stranded conductor in the first compression step.

### Note

The above describes embodiments of the present invention. However, the embodiments described above do not limit the invention claimed in the claims. Furthermore, it should be noted that not all combinations of features described in the embodiments are necessarily essential means for solving the problems of the invention. Moreover, the present invention may be appropriately modified and implemented within the scope that does not deviate from its spirit.

1. A communication cable terminal connection structure to connect a terminal of a communication cable to a substrate,
wherein the communication cable comprises a pair of conductors arranged in parallel and an insulator covering a periphery of the pair of conductors collectively,
wherein the substrate has signal electrodes to which the conductors are electrically connected,
wherein the communication cable has conductor exposed portions exposing the pair of conductors to a predetermined length from an end of the insulator,
wherein the conductors at the conductor exposed portions have connection portions, each connection portion being shaped to have a width in an arrangement direction of the pair of conductors smaller than a height in a direction perpendicular to both the arrangement direction and a longitudinal direction of the conductors,
wherein a spacing between the connection portions is greater than a spacing between the pair of conductors in a covered portion where the conductors are covered by the insulator, and
wherein the connection portions are connected to the signal electrodes respectively by soldering or welding.

2. The communication cable terminal connection structure, according to claim 1, wherein the height of the connection portion is 1.5 times or more and 2.0 times or less the width of the connection portion.

3. The communication cable terminal connection structure, according to claim 1, wherein the connection portion is shaped in such a manner that a portion contacting the signal electrode is planar.

4. The communication cable terminal connection structure, according to claim 1, wherein the spacing between the signal electrodes to which the pair of conductors are connected is 1.01 times or more and 1.30 times or less the spacing between the pair of conductors in the covered portion by the insulator.

5. The communication cable terminal connection structure, according to claim 1, wherein each of the conductors comprises a compressed stranded conductor composed of multiple metal strands being twisted together and compressed to have a circular cross-sectional shape.

6. A communication cable terminal connection method for connecting a terminal of a communication cable to a substrate, wherein the communication cable comprises a pair of conductors arranged in parallel and an insulator covering a periphery of the pair of conductors collectively, and wherein the substrate has signal electrodes to which the conductors are electrically connected, the communication cable terminal connection method comprising:
a conductor exposure step of forming a conductor exposed portion by exposing the pair of conductors to a predetermined length from an end of the insulator in the communication cable;
a connection portion shaping step of forming connection portions by shaping the conductors at the conductor exposed portions in such a manner that each connection portion has a width in an arrangement direction of the pair of conductors smaller than a height in a direction perpendicular to both the arrangement direction and a longitudinal direction of the conductors, while making a spacing between the connection portions larger than a spacing between the pair of conductors in a covered portion covered by the insulator; and
a connection step of connecting the connection portions to the signal electrodes respectively by soldering or welding.

7. The communication cable terminal connection method, according to claim 6, wherein the connection portion shaping step comprises:
a first compression step of compressing the pair of conductors in the arrangement direction;
a second compression step of compressing the pair of conductors in a direction perpendicular to both the arrangement direction and the longitudinal direction after the first compression step.

8. The communication cable terminal connection method, according to claim 7, wherein the connection portion shaping step further comprises a third compression step of recompressing the pair of conductors in the arrangement direction after the second compression step.

9. The communication cable terminal connection method, according to claim 6, wherein each of the conductors comprises a compressed stranded conductor composed of multiple metal strands being twisted together and compressed to have a circular cross-sectional shape, and
wherein the connection portion shaping step comprises a first compression step of compressing the pair of conductors in the height direction and then rotating the compressed portions by 90°.

10. The communication cable terminal connection method, according to claim 9, wherein the compressed portions are rotated in a direction to tighten a twist of the compressed stranded conductor in the first compression step.
